(19) United States
(12) Patent Application Publication
(10) Pub. No.: US 2007/0130282 A1
(43) Pub. Date: Jun. 7, 2007

(54) Computer system and methods therefor

(76) Inventor: David Ryan, Victoria (AU)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 10/575,517

(22) PCT Filed: Sep. 16, 2004
(86) PCT No.: PCT/AU04/01254

§ 371 Date: Apr. 13, 2006

(30) Foreign Application Priority Data
Oct. 14, 2003 (AU) 2003905608
Aug. 5, 2004 (AU) 2004904494

(51) Int. Cl. G06F 15/16

(52) U.S. Cl. 709/217

(57) ABSTRACT

A distributed computer network includes a front interface on a first computer and a corresponding back interface on a second computer wherein instructions communicated from the first to the second computer can be selectively encoded from a set of one or more available encodings. Instructions may also be communicated by encoding the instruction according to a communications protocol selected from a set of available communications protocols. Claims are also directed to a virtual computer, a method of executing an instruction in a virtual computer, and a data format.

### FIELD OF INVENTION

The present invention relates to the field of computing and associated systems, networks and communications. In one form the present invention relates to computers, a computer network, communications system and/or the communications in such devices, systems or networks. In another form, the present invention relates to a distributed computer system or network.

### BACKGROUND ART

As computers become more connected with Internet and wireless technology the software paradigms that have been traditionally used in single CPU programs are requiring to be rethought to meet the demands of distributed computing.

Over the years many solutions have been put forward to deal with distributed applications; starting with basic Remote Procedure Call (RPC) systems through to the Object Management Group (OMG)'s Common Object Request Broker Architecture (CORBA) and more recently the use of eXtensible Mark-up. Language (XML) in Simple Object Access Protocol (SOAP). There are also system dependent propriety systems such as Java's Remote Method Invocation (RMI) and Microsoft's Distributed COM. Additional to these systems which are designed to wrap object methods, there are also Message based systems such as Message Passing Interface (MPI) and Message Queuing (MQ) systems.

Separate to these distributed technologies there is also a movement for computer systems to include multiple CPU's in a single system. Multiple CPU's offer the ability to gain many of the performance characteristics of distributed computing without solving problems such as Data Marshalling. This is due to multiple CPU's sharing the same memory and therefore same architecture. However, to gain the best performance from a multiple CPU system requires the ability to run tasks in parallel to use CPU's resources effectively. There are many problems associated with running tasks in parallel which centre around synchronizing tasks between concurrent threads.

To function effectively distributed computing systems and multiple threaded systems need to overcome a number of problems. These Include:
1. Resource Naming and Resolution—the problem of finding a resource and resolving its location in order to communicate with that resource;
2. Data Marshalling (or serialization)—the problem of taking a program's internal representation of some information and transforming that into a format that can be transferred between computers;
3. Performance—the problem of ensuring that communication channels are used effectively to meet the restraints of current technologies;
4. Object interface replication—the problem of providing a useful Application Programmers Interface (API) that programs can easily access for remote data;
5. Data independence across architectures—Associated with Data Marshalling; the problem of defining a data format which can be transferred and understood between different computer architectures.
6. Data Access Synchronization—the problem of ensuring that data access is synchronized to ensure data resources stay in a correct state and return the correct information; and
7. Security and Resource protection—the problem of ensuring that only valid connections can access the data.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

An object of the present invention is to provide an improvement to a computer, computer network, communications system and/or the communications in such devices, systems or networks.

A further object of the present invention is to alleviate at least one disadvantage associated with the prior art.

### SUMMARY OF INVENTION

The present invention provides, in one aspect of invention, a communications network, having at least two devices adapted to communicate an instruction between the devices, a front interface provided on one computer, and a substantially corresponding back interface provided on the other computer, the improvement comprising selection means for selecting the encoding, for encoding the instruction, from a set of one or more available encodings.

The present invention provides, in another aspect of invention, a method of communicating an instructions from a first device to a second device, the first device having a first interface and the second device having a second interface, the method comprising the steps of selecting a communication protocol from a set of available communication protocols, encoding the instruction in accordance with the selected protocol, and transmitting the encoded instruction from the first device to a second device.

The present invention provides, in another aspect of invention, a virtual computer, comprising an object stack and/or an object heap, each of the stack and heap being adapted to store at least one object and its corresponding type identifier, and an instruction set having at least one instruction adapted for execution by the virtual computer.

The present invention provides, in another aspect of invention, a method of executing an instruction set using a virtual computer, in a communications network having at least two devices, the method comprising the steps of serialising the virtual computer to a data buffer in a first device, and transmitting the data buffer to from the first device to a second device.

The present invention provides, in another aspect of invention, a communications format for use in providing communication between at least two devices, the format comprising a first portion representing data, the first portion being adapted to be rendered and communicated in an electronically communicable format, such as binary format, and a second portion representing metadata for defining a meaning to be given to the first portion, the meaning given to the second portion being definable for each communication.

The present invention provides, in another aspect of invention, a method of communicating between at least two devices, the method comprising the steps of providing a first portion representing data, the first portion being adapted to be rendered and communicated in an electronically communicable format, such as binary format, and providing a second portion representing metadata for defining a meaning to be given to the first portion, the meaning given to the second portion being definable for each communication.

The present invention provides, in another aspect of invention, an architecture for a communication device, the architecture comprising a programming layer for communications internal to the device, a communications layer for communications external to the device, wherein the external communications are in accordance with the format as disclosed herein.

The present invention provides, in another aspect of invention, an architecture for a communication device, the architecture comprising a programming layer for communications internal to the device, a communications layer for communications external to the device, wherein the external communications are in accordance with the selection means as disclosed herein.

The present invention provides, in another aspect of invention, an architecture for a communication device, the architecture comprising a programming layer for communications internal to the device, a communications layer for communications external to the device, wherein the external communications include a virtual computer as disclosed herein.

A number of apparatus and computer programs are also provided in accordance with various aspects of invention, as disclosed herein and/or recited in the claims.

Furthermore, the Data Representation Language (DRL) is one aspect of invention. It provides the data presentation services for communications in the system. It is utilized across communications sub systems in the Colony network object model, and is available to the programmer for any data handling tasks in communications or other Input/Output devices (eg file systems, databases).

The Drone Network Virtual Machine (DNVM), otherwise referred to as a virtual computer, is another aspect of invention and builds on the DRL and provides core services for method based communications. The DNVM provides a movable virtual machine known as a drone that can be passed between hosts to complete tasks before returning to the client.

The Network Object Model (NOM) and Front/Back mechanisms are further aspects of invention and provide CORBA like services using the DNVM and DRL components. Many of the aspects of this have previously been achieved in CORBA, however the NOM allows the developer to choose the best implementation for remote method invocation. This is not possible in CORBA where all communications are locked and defined by the OMG specification.

The Front object provides the interface definition of the functionality to be provided on a remote client. An implementation of the Front object provides the specific encoding mechanisms required for the client to communicate with the host. The Back interface provides the matching server elements required deliver the message from client to Back. An implemented Back object provides the matching decoding mechanisms for the implemented Front object.

The Zone/Realm system is a further aspect of invention and provides the object grouping required for the Naming system. A Realm also provides the security mechanisms required to protect object access from objects external to a Realm.

The Node system is a further aspect of invention and provides messaging services to an object. These messaging services allow messages to be asynchronously delivered to an object. It additionally provides services to allocate threads dynamically on an as needed basis to handle messages directed to the object. This provides for intelligent functionality to be assigned to an object.

The Messaging system is a further aspect of invention and combines with the Naming and Node system to provide an internal message based system. Messaging systems are normally designed for external system, while Colony's is designed for both internal and external communications.

The Naming system is a further aspect of invention and links in with the Zone/Realm system to provide objects to be published and made available using Uniform Resource Locators.

The Zone is a further aspect of the invention and provides the ability to group objects for Naming and resolution purposes. The Zone provides the object container to allow objects to be managed. A Zone may be implemented to best suite the objects it contains.

The Realm is a further aspect of the invention and extends the functionality of a Zone to provide security services to a Zone. A Realm ensures that a user identifier and pass key is required to access the objects and Nodes which reside inside the Realm.

The Zone/Realm, Node & Messaging components, in combination, is a further aspect of invention and all operate in the program and work very closely together. The Zone/Realm is used to locate, name and/or provide security access to objects.

The Data Channel is a further aspect of invention and provides a streaming system to individual objects in the environment, and is considered inventive in so far as it brings these services directly to an object. This Streaming system provides services for two objects to create a data pipe directly between two objects. A program does have the ability to use the colony communication tools to create is own additional session, presentation and application layer protocols over this stream. This data channel provides a mechanism to link two objects across a client/server environment.

The Data Session is a further aspect of invention and describes how two hosts can negotiate and agree on how different data elements should be transferred. This protocol defines the messages required to agree on the formats of each element.

The Channel Link Server defines the session layer protocol which accepts and connects Data Channels from client to server.

The Transport Link Layer is a further aspect of invention and is specific to the needs to the transport layer being used. The Transport Link Layer connects the Colony communications services to such transport layers as simple TCP/IP socket, secure SSL link or other transport medium. The data session and channel link server are specific to the needs of the link layer being used. They provide the session management between the client and server. This is because a message based transport layer may have requirements differing from stream based transport layers.

Other aspects and preferred aspects are disclosed in the specification and/or defined in the appended claims, forming a part of the description of the invention.

Advantageously, it has been found that the problem of:
Resource Naming and Resolution can be addressed by using Internet standard Uniform Resource Locator (URL);
Data Marshalling (or serialization) can be addressed by using a Data Representation Language (DRL(pron. Drill));
Performance can be addressed by Messaging, Streaming and/or a Drone Network Virtual Machine (DNVM);
Object interface replication can be addressed by providing a Front/Back object paradigm which is contained in its Network Object Model (NOM);
Data independence across architectures can be addressed with the Data Representation Language (DRL);
Data Access Synchronization can be addressed with dynamic thread allocation to objects:
Security and Resource protection can be addressed by use of the object containment interfaces (Realms) and operating system to provide these services.

In essence, the present invention by use of the distributed object computing system of the present invention provides an architecture which resolves many prior art and operational issues in a relatively coherent and well defined way. The present invention, in one form, separates the solution to each problem into well defined sub systems which when combined together provide a solution to distributed computing.

The present invention provides a new architecture for distributed computing systems and a multiple threaded system which is also referred to as Colony in this specification. For the Colony architecture to be effective it requires many new inventions to address the problems of existing distributed computing systems.

The Colony system is designed to remove the barriers of single address space applications and allow individual objects to interact with objects internal and external to an application. The Colony system provides services to individual objects such as naming objects, resolving the location of objects, asynchronous messaging to objects, remote method invocation & remote streaming.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DESCRIPTION OF DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates the components of one embodiment of the present invention;

FIG. 2 illustrates a drone according to one aspect of the present invention;

FIG. 3 illustrates an object being called remotely from another type of front interface from another client;

FIG. 4 illustrates a comparison between OSI, TCP/IP and the present invention;

FIG. 5 illustrates a message based communication;

FIG. 6 illustrates a stream based communication;

FIG. 7 illustrates a remote procedure based communication;

FIG. 8 illustrates the concept of a proxy object on a client;

FIG. 9 illustrates a Front/Back object combination to handle remote access to an object; and

FIG. 10 illustrates a concept of a Stub & Skeleton which provides for default implementations for Front & Back objects;

FIG. 11 illustrates communication with objects; and

FIG. 12 illustrates the naming of objects.

### DETAILED DESCRIPTION

Colony provides a set of tools and services to allow a developer to build networked applications. These services are designed around providing methods of communications between objects residing both within an application and located external to an application in a transparent manner. Providing services designed for individual objects instead of an application is a key aspect of the Colony design philosophy.

The broad design of Colony centres around the ability for objects to deliver services to other objects residing in the same address space or external address spaces. Providing transparency between local and remote objects ensures ease of development.

The Colony system provides additional messaging capabilities. This allows asynchronous messages to be delivered and processed directly by an object. This improves on other messaging systems where the messaging service is external to the object.

The Colony system provides additional streaming capabilities directly to an object. This allows data pipes to be opened between objects operating on the same host or different hosts.

The Colony system ties these services together with a single naming system based on the Uniform Resource Locator. The URL encoding ensures ease of communication of object or services between programs or users of programs in the same way a HTTP address can be cut and pasted between applications.

The CORBA approach to distributed computing suffers from a number of deficiencies including: a strict data type representation which makes It difficult to extend data types; has strict implementation requirements which makes communications inflexible under certain situations; and is intrusive to the application program. Colony takes a different conceptual view of data, objects and distributed computing and the mechanisms for communicating between distributed objects.

The SOAP and XML services approach to data communications suffers from ambiguous data text representation. This makes it difficult to agree on data formats and send binary data in an efficient manner. Colony's use of a Data Representation Language (DRL) provides a conceptually different approach to solving distributed computing.

The Colony system makes the programming task simpler and the final application significantly more efficient than a system developed in either CORBA or using XML based communications.

Colony Overview

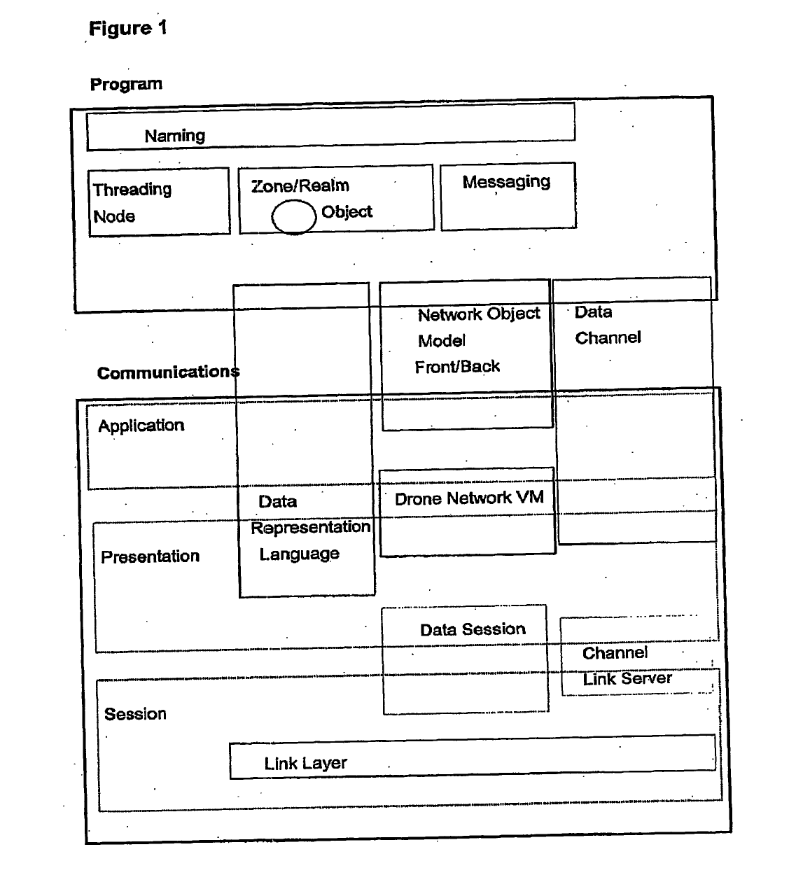

The description above has highlighted a few of the features employed by the Colony Distributed Object Computing System (CDOCS), which is the name given to one aspect of the present invention. These solutions are designed to provide the necessary services to an object to allow it to operate within a distributed computing environment. FIG. 1 illustrates the components of a CDOCS and how an object relates to each component.

The overall architecture and elements described above is inventive as it separates known and unknown distributed computing elements into easier to understand components. The overall invention of bringing these components together is important as it has separated a very complex problem into a number of smaller problems.

The Data Representation Language (DRL) is one aspect of invention. It provides the data presentation services for communications in the system. It is utilized across communications sub systems in the colony network object model, and is available to the programmer for any data handling tasks in communications or other Input/Output devices (eg File system or Database).

The Data Session is another aspect of invention and describes how two hosts can negotiate and agree on how different data elements should be transferred. This protocol defines the messages required to agree on the formats of each element.

The Drone Network Virtual Machine (DNVM) is another aspect of invention and uses the DRL to provide core services for method based communications. The DNVM provides a movable virtual computer known as a drone that can be passed between hosts to complete tasks before returning to the client.

The Network Object Model (NOM) and Front/Back mechanisms are another aspect of invention and provide services using the DNVM and DRL components. NOM allows the developer to choose the best implementation for remote method invocation. This is not possible in prior art, such as CORBA where all communications are locked and defined by the OMG specification.

The Front object provides the interface definition of the functionality to be provided on a remote client. An implemented Front object provides the specific encoding mechanisms required for the client to communicate with the host. The Back interface provides the matching server elements required to deliver the message from client to Back. An implemented Back object provides the matching decoding mechanisms for the implemented Front object.

The Data Channel is another aspect of invention and provides a streaming system to individual objects in the environment, and brings these services directly to an object. This Streaming system provides services for two objects to create a data pipe directly between two objects. A program has the ability to use the colony communication tools to create its own additional session, presentation and application layer protocols over this stream. This data channel provides a mechanism to link two objects across a client/server environment.

The Channel Link Server is another aspect of invention and defines the session layer protocol which accepts and connects Data Channels from client to server. The Naming system is another aspect of invention and links with the Zone/Realm system to provide objects to be published and made available using Uniform Resource Locators.

The Zone is a further aspect of the invention and provides the ability to group objects for Naming and resolution purposes. The Zone provides the object container to allow objects to be managed. A Zone may be implemented to best suit the objects it contains. The Realm is a further aspect of the invention and extends the functionality of a Zone to provide security services to a Zone. A Realm ensures that a user identifier and pass key is required to access the objects and Nodes which reside inside the Realm.

The Node system is a further aspect of invention and provides messaging services to an object. These messaging services allow messages to be asynchronously delivered to an object. It additionally provides services to allocate threads dynamically on an as needed basis to handle messages directed to the object. This provides for intelligent functionality to be assigned to an object.

The Messaging system is another aspect of invention and combines with the Naming and Node system to provide an internal message based system. Messaging systems are normally designed for external systems, while Colony's is designed for both internal and external communications

The Zone/Realm, Node & Messaging components operate in the program and work very closely together.

The Link Layer is another aspect of invention and is specific to the needs of the transport layer being uses. The Transport Link Layer connects the Colony communications services to such transport layers as a simple TCP/IP socket, secure SSL link or other transport medium. The data session and channel link server are specific to the needs of the link layer being used. They provide the session management between the client and server. This is because a message based transport layer may have requirements differing from stream based transport layers.

Data Representation Language (DRL) (pronounced Drill)

One of the fundamental problems to be solved in exchanging data between computers is Data Presentation (also known as Marshalling or serialization). This task involves placing data stored in memory, and used by a program, into a format which can be sent over a serial connection or stored in a way that another program can read that data at a later time. This covers both data communications and data storage in File systems or Databases.

This problem can be demonstrated by a date such as 15/8/2003. To a human reader this date is reasonably easy to interpret as the Aug. 15, 2003. A date such as 5/4/2003 is a little more difficult to interpret as it could either be Apr. 5, 2003, or May 4, 2003; as it could either be in American or Australian date format. The same problem happens through-out computer communication systems, and happens with even the most basic data. For instance, the number 42 can be stored or transmitted in a number of ways. For instance, a computer with an Intel architecture might store this as an unsigned 8-bit big endian format. In the computer's memory (RAM) this is as binary:
0 0 1 0 1 0 1 0

The same number could be stored as 16-bit little endian format:
0 1 0 1 0 1 0 0 0 0 0 0 0 0 0 0

Without an agreement on format, two computers can not communicate. This problem becomes much larger as the data being transferred becomes more complex. A simple string “Hello” can have a number of different encodings. Some examples are ASCII, EBCDIC, UTF-8, ISO8859 and UNICODE; although many other encodings exist. A simple example would be ASCII format which is encoded as binary 8-bit big endian format.

| H | E | L | L | O |
|---|---|---|---|---|
| 01001000 | 01000101 | 01001100 | 01001100 | 01001111 |

If this set of binary data was sent between two computers the receiving computer would still not be able to decode or recognise the meaning. Additional information needs to be sent with the data to describe its contents. In this case an agreed way of identifying that this is an ASCII string and has a length of 5 bytes stored as big-endian 8 bit bytes might be to include a type id 3 that both the sender and receiver use to identify being a string. This type id is then followed by the number 5 which describes the length:

TABLE A

| TYPE 3 | length 5 | H | E | L | . . . |
|---|---|---|---|---|---|
| 00000011 | 00000101 | 01001000 | 01000101 | 01001100 | . . . |

This mechanism of agreeing on the type of data then adding additional information such as length and byte ordering is a method used in such systems as CORBA's General Inter-ORB Protocol (GIOP). The GIOP defines a known set of data TypeCodes which for instance define the value 18 to mean a string which has the string's length defined by a unsigned long (32bit) value. This definition is defined in the CORBA specification and must be implemented as such on every CORBA system.

While CORBA's GIOP data specification could be used to store data in a file or database, it would be unlikely to see such a scenario as the CORBA specification is designed specifically for client/server communication.

The Colony DRL is designed to solve the problem of data encoding in a highly flexible way which can be applied to data storage, communications and databases. This is achieved by recognizing that the total information about some binary data is made up of the combination of the data itself and the data which describes that data (metadata). In the case of GIOP and many other systems the meta data is stored in a specification document external to the software system and encapsulated in the code used to read the data. The metadata is not available in its entirety to be analysed separately by a program or modifiable by a developer.

Colony's DRL provides a language which serves two functions, it is used to describe the data, and provides instructions on how to read/write that data when it is received or transmitted. The language in its most basic form describes a specific data type. The DRL in a full implementation provides the ability for two devices to agree on the methods and format of how data is presented. As an example of the text above, we might describe an ASCII string as
ascii_string: array(unsigned_eight_bit, unsigned_eight_bit)

The above line uses an array function that takes two parameters. The first parameter specifies that the length of the array will be specified by an unsigned eight bit value, and the data will be made up of unsigned eight bit values. This information can now be used to read an ASCII string.

This description could be sent with the string in Table A to describe the contents of the data. This would result in the following communications
ascii_string: array(unsigned_eight_bit, unsigned_eight_bit)
0x05 H E L L O

The first part describes the format of the second part. If we were to use this in a real application, the communications in describing the content of the data would take more bandwidth than the data itself. As described earlier a common method of reducing the traffic is to associate a tag with the type. By associating the tag 3 with the definition of ascii_string we can then simply send the data described in Table A; however in DRL it is necessary to associate the identifier with a function to read an identified type, and then using that identifier read the following data. To do this we need to define a function to read a specific value which identifies a specific data type (typed data).
typed_data: identified(unsigned_eight_bit, any)

The above line specifies that we can read any unknown data by first reading a single byte followed by any type of recognised data (The any type is a special tag used as a marker that any data can be read). Using the example in Table A, we nearly have enough metadata to be able to read and understand the data.

At this point we have created a method of describing the binary data to be sent We have recognised the need to send a type identifier instead of the full data description every time. Using the DRL we have created a descriptor to read typed data, however at this point we have not associated the type tag three with an ascii_string descriptor.

To associate data types with the specific tags, the invention provides a map that specifies that an identifier is associated with a specific data type. In the example above the following map is required.

| Identifier | Data Type |
|---|---|
| 3 | ascii_string |
| 6 | typed_data |

The identifier above is the external identifier required when communicating the data from Table A. The Colony DRL additionally uses an internal type identifier to tag each type defined, this type identifier is preferably used internally only. Different applications will want to use different Identifiers in different external data representations (i.e. through system revisions, or to be compatible with external systems). A type map is therefore needed to map an external identifier to our internal data type identifier.

TABLE B

| External | Internal | Data Type |
|---|---|---|
| 1 | 10 | unsigned_eight_bit |
| 3 | 15 | ascii_string |
| 6 | 16 | typed_data |

Table B above provides an External representation id. Now, to read the data described in Table A, it is necessary to read data from the stream of type 6. This will resolve to the internal type identifier 16 which is a typed_data type. The function identified will read a single byte and use that to look up the type of data to read. Returning the value 3, the identified function will map this to the internal identifier 15 and read the type ascii_string. This will call the array function and read a single byte for the length and then that number of bytes from the data stream.

The current implementation allows for tags to be implemented using integers and mapping the value to the internal type descriptor. An alternative Implementation would also allow other tag types such as ascii strings to be created and a corresponding mapping to internal type descriptor. Integers are used in this embodiment as it is more efficient for data bandwidth and programming efficiency.

The DRL provides the flexibility for a programmer to create their own unique functions in the DRL for any type of data. For example it is often Important for performance reasons to create a specific function to read some binary data types. For example a single function would be used to read large Images. The new function would be used instead of using the DRL array function.

The DRL specifies the data representation as written in binary. It does not specify how each data type is specified in a specific language or operating environment. In a java system, for instance, the type ascii_string can be resolved as a java.lang.string type for programming purposes.

The Colony DRL functionality is also designed for complex objects. A Person object for example may include a number of details such as first name, last name and date of birth. This would be defined in DRL as:

TABLE C

person: ascii_string[firstName] ascii_string[lastName]
date_basic[dateOfBirth]

where the date_basic is defined as:

date_basic: unsigned_eight_bit[day] unsigned_eight_bit[month] signed_sixteen_bit[year]

Using this definition, a person John Smith born on Feb. 1, 1973 can be defined as:

TABLE D

| | John | Smith | 1/2/1973 |
|---|---|---|---|
| (hex) | 04 4A 6F 68 6E | 05 5E 6D 69 74 68 | 01 02 07 65 |

The DRL provides the ability to describe any data and record that information separately from the data being described.

A further aspect of the Colony DRL is that the metadata can also be serialized and sent between servers so that type agreement can be performed. Take for example the person object from Table C. If an object on one machine would like to send an object (eg a Person as above) it must be able to agree that the person object definitions are the same. This can be done by serializing the definition of the person meta data. A structural representation of the Person meta data might be defined as:

```
type_def(
  Sequence(
    type_ref( ascii_string, “firstName” ),
    type_ref( ascii_string, “lastName” )
    type_ref( date_basic, “dateOfBirth” )
  )
)
```

Using this example metadata, the following meta type descriptors may be defined:

```
  type_ref: unsigned_short_big[typeld] ascii_string[dataName]:
  sequence:  array(  unsigned_short_big,  identified
unsigned_short_big(type_ref ) );
  type_def: identified( unsigned_short_big, sequence );
```

To serialize the example person metadata it is necessary to be able to record the description of the metadata and the types that it describes. To accomplish this two different type maps are required. The metadata type map defines an agreed set of types to communicate meta data, while the metadata type reference is used as a reference for the types being defined:

Meta Data
Type Map

| External | Internal | Type |
|---|---|---|
| 1 | 1 | unsigned_short_big |
| 2 | 2 | unsigned_long_big |
| 3 | 3 | ascii_string |
| 4 | 4 | type_ref |
| 5 | 5 | sequence |
| 6 | 6 | type_def |

Reference
Type Map

| External | Internal | Type |
|---|---|---|
| 1 | 1 | unsigned_short_big |
| 2 | 3 | ascii_string |
| 3 | 7 | date_basic |
| 4 | 6 | type_def |

Using this information the person metadata can be serialized:

| Type Id 5 | Length 3 | Type Ref |
|---|---|---|
| (sequence) | (Type 4) | (ref type) (len) (description) |
| (Hex) 00 05 | | |
| | 00 03 | |
| | | (type_ref)(ascii_string)(“firstName”) |
| | | 00 04 00 02 09 46 49 52 53 54 2E 41 4D 45 |
| | | (type_ref)(ascii_string)(“lastName”) |
| | | 00 04 00 02 08 4C 41 53 54 2E 41 4D 45 |
| | | (type_ref)(date_basic)(“dateOfBirth”) |
| | | 00 04 00 03 08 44 41 54 45 2F 46 22 |
| | | 49 52 54 48 |

The identifiers marked in ‘bold text’ represent those from the Meta Data Type Map, while those identifiers underlined are from the Reference Type Map.

The full data representation is thus:

| | |
|---|---|
| (hex) | 00 05 00 03 00 04 00 02 09 46 49 52 53 54 2E 41 |
| | 4D 45 00 04 00 02 08 4C 41 53 54 2E 41 4D 45 00 |
| | 04 00 03 08 44 41 54 45 2F 46 22 49 52 54 48 |

The number of type maps used to communicate can be varied. Each communication method using the same data is able to use a different type map for different situations. For instance one type map and therefore data serialization can be used when saving to file, while another is used for data communications.

To ensure that distributed systems are able to communicate metadata correctly, it is important that the meta data itself have metadata. This allows two host to ensure they agree on the method of communicating metadata. This creates a self referenced description of the metadata. Using the example of type_ref, we are able to serialize its definition as:

| Type Id 5 | Length 2 | Type Ref |
|---|---|---|
| (sequence) | (Type 4) | (ref type) (len) (description) |
| (Hex) 00 05 | | |
| | 00 02 | |
| | | (type_ref)(type_ref)(“refType”) |
| | | 00 04 00 01 07 52 45 46 34 59 50 45 |
| | | (type_ref)(type_ref)(“typeDesc”) |
| | | 00 04 00 02 08 54 59 50 45 24 45 53 43 |

This metadata uses its own type definition to describe itself. For two systems to agree on metadata used to describe other data the only way to boot strap the process is to compare the metadata binary information. If the binary information matches, the metadata descriptions are compatible and metadata can be read/processed.

Colony DRL can be used to uniquely describe information contained in any binary data. Many other distributed computing environments describe both the data and the method of communication in a strict fashion. This limits their ability to represent and communicate a wide range of data type presentations. The DRL simply provides a method which describes the data and creates an unambiguous set of instructions on how to read the data. This provides the opportunity for the system to be used for both communicating data as well as data information storage and retrieval from both databases and file systems.

Various aspects of the Colony Distributed Object Computing System utilize the type system for communications.

Data Representation Language (DRL) Implementation—First Embodiment

The Colony Distributed network system implements the DRL. This implementation is one possible implementation of the various components which make up the DRL.

In one embodiment, each type is described using a specific language defined by the following grammar:
entry: IDENTIFIER (‘[’IDENTIFIER‘]’)?‘:’ specification‘;’
specification: basic|sequence
sequence: exclusive (sequence)?
exclusive: element (exclusive)?
element: reference|function
reference: IDENTIFIER (‘[’IDENTIFIER‘]’)?
function: IDENTIFIER ‘(’sequence‘)’
basic: ‘basic’ INT INT
IDENTIFIER: (‘a’ . . . ‘z’|‘A’ . . . ‘Z’)(‘a’ . . . ‘z’|‘A’ . . . ‘Z’|‘0’ . . . ‘9’|‘.’)*
INT: (DIGIT)+
DIGIT: ‘0’ . . . ‘9’
   Additional elements could be defined in future to add additional information about data presentation. One example of this is the addition of an element to constrain the value of an element to a specific set.

Using the above grammar it is possible to define the base metadata definitions required to represent this grammar data in a binary form. The elements are only defined using the grammar defined. This creates the self referenced grammar required for the base of the DRL:

empty: basic 0 0;

The empty type is a place holder for a type that has no data associated. This can be useful for identifying specific data which has no additional information associated other than the identifier itself.

U8B: basic 8 0;

This is a basic element which reads an unsigned eight bit big endian number between 0 and 255. The value in java is returned java.lang.integer.

U16B: basic 16 0;

This is a basic element which reads an unsigned sixteen bit big endian number between 0 and 65536. The value in java is returned as a java.lang.integer object.

basic: U8B[size] U8B[flags];

This defines how the meta data associated with meta data is serialized. Two values of unsigned 8 bit values. The first value is the size if available and the second value is additional flags. These data types are atomic values which require specific function to read the values.

type_ref: U16B;

A type reference is used to refer to a type which is used in the definition of another type.

any: empty;

The any type is an identifier used by the identified function, to mean any type of data can be read.

func_ref: U16B identified (any);

A function reference defines the use of a function when reading a type. The initial value is the specific function to be used. The second identified value represents additional information that can be used by the function.

identified: U16B;

The identified function reads a single U16B and uses this value to read the type following in the data stream. The identified function however uses additional information defined by the meta data to allow constraints to what types of data can be read in the stream.

array: U8B;

The array function reads a set of objects. The length of the array is specified by a single U8B which constrains the length of the array between 0 and 255 elements.

sequence: array(identified(type_ref|func_ref));

The sequence function is used to define a sequence of elements in a data definition. A sequence is defined by the sequence in the DRL grammar.

exclusive: array(identified(type_ref|func_ref ));

The exclusive set is used by the identified function to constrain the types of elements that can be read after an identifier is read from the stream. The exclusive set is built into the grammar with the | list.

definition: identified(exclusive(basic|sequence));

A type definition is an identified type which can either be a basic type or sequence type.

The ability to serialize these definitions is another aspect of the DRL. Using the above definitions only, it must be possible to serialize each type. This creates a purely self referenced system. An example is given in the following type map to identify each type:

| Identifier | Type |
|---|---|
| 1 | empty |
| 2 | u8b |
| 3 | u16b |
| 4 | basic |
| 5 | type_ref |
| 6 | any |
| 7 | func_ref |
| 8 | identified |
| 9 | array |
| 10 | sequence |
| 11 | exclusive |
| 12 | definition |
| 13 | ascii_string |

The type map used is the same for both identifying the data and for referencing other types in type_ref and func_ref data. We are then able to serialize each of the types as a definition:

| empty: basic 0 0; | | |
|---|---|---|
| | (basic) | (size)(flags) |
| (hex) | 00 04 | |
| | | 00 00 |
| u8b: basic 8 0; | | |
| | (basic) | (size) (flags) |
| (hex) | 00 04 | |
| | | 08 00 |
| u16b: basic 16 0; | | |
| | (basic) | (size)(flags) |
| (hex) | 00 04 | |
| | | 10 00 |
| basic: u8b u8b; | | |
| | (sequence) | (type reference) |
| (hex) | 00 0A 02 | |
| | | 00 05 00 03 |
| | | 00 05 00 03 |
| typeref: u16b; | | |
| | (sequence) | (type reference) |
| (hex) | 00 0A 01 | |
| | | 00 05 00 03 |
| any: empty; | | |
| | (sequence) | (type reference) |
| (hex) | 00 0A 01 | |
| | | 00 05 00 01 |
| funcref: U16B identified( funcref \| exclusive ); | | |
| (hex) | (sequence) | (exclusive) |
| | 00 0A 02 | |
| | | 00 05 00 03 |
| | | 00 07 00 08 |
| | | 00 0b 02 |
| | | 00 05 00 07 |
| | | 00 05 00 0B |
| identified: U16B; | | |
| (hex) | (sequence) | |
| | 00 0A 01 | |
| | | 00 05 00 01 |
| array: U8B; | | |
| (hex) | (sequence) | |
| | 00 0A 01 | |
| | | 00 05 00 03 |
| sequence: array( identified( typeref \| funcref ) ); | | |
| (hex) | 00 0A 01 | |
| | | 00 07 00 09 |
| | | 00 07 00 08 |
| | | 00 0B 02 |
| | | 00 05 00 05 |
| | | 00 05 00 07 |
| exclusive: array( identified( type_ref ) ); | | |
| | (sequence) | (func_ref) (exclusive) |
| (hex) | 00 0A 01 | |
| | | 00 07 00 09 |
| | | 00 07 00 08 |
| | | 00 0B 01 |
| | | 00 05 00 05 |
| definition: identified( basic \| sequence ); | | |
| | (sequence) | (func_ref) (exclusive) |
| (hex) | 00 0A 01 | |
| | | 00 07 00 08 |
| | | 00 0B 02 |
| | | 00 05 00 04 |
| | | 00 05 00 0A |
| ascii_string: array( U8B ); | | |
| (hex) | (sequence) | (func_ref) |
| | 00 0A 01 | 00 07 00 09 |
| | | 00 0B 01 |
| | | 00 05 00 02 |

Using these serialized type definitions a client and server are able to confirm the format of metadata before attempting to communicate metadata information. These definitions would be written to an array:

metadef: array(definition);

which would result in the following:

0C 00 04 00 00 00 04 08 00 00 04 10 00 00 0A 02 00 05 00 03 00 05 00 03 00 0A 01 00 05 00 03 00 0A 01 00 05 00 01 00 0A 02 CO 05 00 03 00 07 00 08 00 0b 02 00 05 00 07 00 05 00 0B 00 0A 01 00 05 00 01 00 0A 01 00 05 00 03 00 0A 01 00 07 00 09 00 07 00 08 00 0B 02 00 05 00 05 00 05 00 07 00 0A 01 00 07 00 09 00 07 00 08 00 0B 01 00 05 00 05 00 0A 01 00 07 00 08 00 0B 02 00 05 00 04 00 05 00 0A

A typical client server communications system would first send this data and the server would confirm that it matches the server side serialized date representation. Until the metadata is compared and matched at a binary level, the server will not be able to confirm that the data can be read successfully. The present invention provides a reduced communications length between machines due to the agreement on data structure.

Data Representation Language (DRL) Implementation—Second Embodiment

As noted above, the Colony Distributed network system implements the DRL. The following Implementation is another implementation of the Data Representation Language dictionary of elements.

In this embodiment, each type is described using a specific language defined by the following grammar:

```
entry: IDENTIFIER “:” expression “;”
expression: IDENTIFIER “(“ primarylist “)”
  | { primarylist }
primarylist: ( p=primary ( “,” p=primary )* )
primary: expression
  | integer
  | quoted_string
  | “[“ expression ( “,” expression )* “]”
  | “#” IDENTIFIER
  | “@” ref:IDENTIFIER “[“ quotedstring “]”
IDENTIFIER: (‘a’..‘z’|‘A’..‘Z’)(‘a’..‘z’|‘A’..‘Z’|‘0’..‘9’|‘.’|‘_’|‘#’)*
```

This grammar allows additional elements to be defined in future to add additional information about data presentation. One example of this is the addition of an element to constrain the value of an element to a specific set.

Using the above grammar it is possible to define the base metadata definitions required to represent this grammar data in a binary form. The elements are only defined using the grammar defined. This creates the self referenced grammar required for the base of the DRL:

empty: meta.basic(0, 0);

The empty type is a place holder for a type that has no data associated. This can be useful for identifying specific data which has no additional information associated other than the identifier itself.

u8: meta.basic(8, 0);

This is a basic element which reads an unsigned eight bit big endian number between 0 and 255. The value in java is returned java.lang.integer.

u16: meta.basic(16, 0);

This is a basic element which reads an unsigned sixteen bit big endian number between 0 and 65536. The value in java is returned as a java.lang.integer object.

meta.basic:

```
{
  @u8[“size”],
  @u8[“flags”]
};
```

This defines how the meta data associated with mete data is serialized. Two values of unsigned 8 bit values. The first value is the size if available and the second value is additional flags. These data types are atomic values which require specific function to read the values.

meta.name:

```
{
  meta.encoding(
    meta.array(
      @u8[“size”],
      @u8[“data”]
    ),
    “ISO646-US”
  )
};
```

A name is a simple ASCII encoded string of maxiumum length 255 characters. This is used to describe the names of each type in the DRL system.

meta.abstract

{
@empty[“abstract”]
};

A type defined as abstract has an empty definition. The abstract data type is an important concept in the DRL. It allows a concept to be defined which has no definition associated. A map is used to associate a concrete representation with an abstract data type. This allows the DRL system to be expanded by the user without modifying types previously defined.

meta.map:

```
{
  @u16[“abstract”],
  @u16[“concrete”]
};
```

A map is used to map an abstract data type to a concrete data type. Two u16 values are used to specify the data types in the dictionary being mapped.

meta.expression: meta.abstract( );

An expression is an abstract type. It allows different expressions to be used to define data types. New expressions can be added to expand DRL specification language.

meta.encoding:

```
{
  @meta.expression[“data”],
  @meta.name[“encoding”]
};
```

Encoding specifies the data encoding used on a character string. The data expression must return an array that can have encoding applied.

meta.reference:

```
{
  @u16[“type”],
  @meta.name[“name”]
};
```

A reference delcares a usage of another data type in the system. The name data type is used to define a description of usage of that data type. A reference is defined using the @ type “[”name“]” syntax in the definition given.

meta.sequence:

```
{
  meta.array(
    @u8[“size”],
    @meta.expression[“type”]
  )
};
```

A sequence defines a set of expressions which are executed in order. In the most normal case, it defines an ordered set of types in a data buffer. A sequence is defined as “≡”“□” in the grammar defined to describe argot definitions.

meta.array:

```
{
  @meta.expression[“size”],
  @meta.expression[“type”]
};
```

An Array is used to define any collection of data with a size and a type. The abstract type expression is used to define how the size and type is specified.
meta.expression#reference: meta.map(#Meta.expression, #meta.reference);
meta.expression#sequence: meta.map(#meta.expression, #meta.sequence);
meta.expression#encoding: meta.map(#meta.expression, #meta.encoding);

The abstract expression type is mapped to reference, sequence and encoding. Any of the concrete types can be used in place of the expression type.
meta.definition: meta.abstract( );

The definition of a type is abstract. Specific concrete types are mapped to the abstract type.
meta.definition#basic: meta.map(#meta.definition, #meta.basic);
meta.definition#sequence: meta.map(#meta.definition, #meta.sequence);
meta.definition#map: meta.map(#meta.definition, #meta.map);
meta.definition#abstract: meta.map(#meta.definition, #meta.abstract);

A definition is defined as being basic, sequence, map or abstract.

The ability to serialize these definitions is another aspect of the DRL. Using the above definitions only, it must be possible to serialize each type. This creates a purely self referenced system. An example is given in the following type map to identify each type:

| Identifier | Type |
|---|---|
| 1 | empty |
| 2 | u8 |
| 3 | u16 |
| 4 | meta.basic |
| 5 | meta.abstract |
| 6 | meta.map |
| 7 | meta.expression |
| 8 | meta.sequence |
| 9 | meta.reference |
| 10 | meta.name |
| 11 | meta.encoding |
| 12 | meta.array |
| 13 | meta.expression#reference |
| 14 | meta.expression#sequence |
| 15 | meta.expression#array |
| 16 | meta.expression#encoding |
| 17 | meta.definition |
| 18 | meta.definition#basic |
| 19 | meta.definition#map |
| 20 | meta.definition#sequence |
| 21 | meta.definitino#abstract |

The type map used is the same for both identifying the data and for referencing other types in meta.reference type data. We are then able to serialize each of the types as a definition:

| empty: meta.basic( 0, 0 ); | |
|---|---|
| (meta.definition#basic) | (size)(flags) |
| (hex) 00 12 | |
| | 00 00 |
| u8: meta.basic( 8, 0 ); | |
| (meta.definition#basic) | (size) (flags) |
| (hex) 00 12 | |
| | 08 00 |
| u16: meta.basic( 16, 0 ); | |
| (meta.definition#basic) | (size)(flags) |
| (hex) 00 12 | |
| | 10 00 |

meta.basic: { @u8[“size”], @u8[“flags”] };

| | |
|---|---|
| (meta.definition#sequence) | (type references) |
| (hex) 00 14 02 | |
| | 00 0D 00 02 04 73 69 7A 65 |
| | 00 0D 00 02 05 66 6C 61 67 63 |

meta.abstract: { @empty[“abstract”] }

| | |
|---|---|
| (meta.definition#sequence) | (type references) |
| (hex) 00 14 01 | |
| | 00 0D 00 01 08 61 62 73 74 72 61 63 74 |

meta.map: { @u16[“abstract”], @u16[“concrete”] };

| | |
|---|---|
| (meta.definition#sequence) | (type references) |
| (hex) 00 14 02 | |
| | 00 0D 00 03 08 61 62 73 74 72 61 63 74 |
| | 00 0D 00 03 08 63 6F 6E 63 72 65 74 65 |

meta.expression: meta.abstract( );
(meta.definition#abstract)
(hex) 00 15
meta.sequence: { meta.array( @u8[“size”], @meta.expression[“type”] ) };
(meta.definition#sequence)
(meta array)

| | |
|---|---|
| | (type reference) |
| (hex) 00 14 01 | |
| 00 0F | |
| | 00 0D 00 02 04 73 69 7A 65 |

00 0D 00 07 04 74 79 70 65
meta.reference: { @u16[“type”], @meta.name[“name”] };

| | |
|---|---|
| (meta.definition#sequence) | (type references) |
| (hex) 00 14 02 | |
| | 00 0D 00 03 04 74 79 70 65 |
| | 00 0D 00 0A 04 6E 61 6D 65 |

```
meta.name: { meta.encoding( meta.array( @u8[“size”],@u8[“data”]),
    “ISO646-US”) };
(meta.definition#sequence)
    (meta encoding)
```

| | |
|---|---|
| | (meta array) |
| (hex) 00 14 01 | |
| 00 10 | |
| | 00 0F |
| | 00 0D 00 02 04 73 69 7A 65 |
| | 00 0D 00 02 04 64 61 74 61 |

09 49 53 4F 36 34 36 2D 55 53
meta.encoding: { @meta.expression[“data”], @meta.name[“encoding”] };

| | |
|---|---|
| (meta.definition#sequence) | (type references) |
| (hex) 00 14 02 | |
| | 00 0D 00 07 04 64 61 74 61 |
| | 00 0D 00 0A 08 65 6E 63 6F 64 69 6E 67 |

meta.array: { @meta.expression[“size”], @meta.expression[“type”] };

| | |
|---|---|
| (meta.definition#sequence) | (type references) |
| (hex) 00 14 02 | |
| | 00 0D 00 07 04 73 69 7A 65 |
| | 00 0D 00 07 04 74 79 70 65 |

meta.expression#reference: meta.map( #meta.expression,
#meta.reference );
(meta.definition#map)
(hex) 00 013 00 07 00 09
meta.expression#suquence: meta.map( #meta.expression,
#meta.sequence );
(meta.definition#map)
(hex) 00 013 00 07 00 08
meta.expression#array: meta.map( #meta.expression, #meta.array );
(meta.definition#map)
(hex) 00 013 00 07 00 0C
meta.expression#encoding: meta.map( #meta.expression,
#meta.encoding );
(meta.definition#map)
(hex) 00 013 00 07 00 0B
meta.definition: meta.abstract( );
(meta.definition#abstract)
(hex) 00 015
meta.definition#basic: meta.map( #meta.definition, #meta.basic );
(meta.definition#map)
(hex) 00 013 00 11 00 04
meta.definition#map: meta.map( #meta.definition, #meta.map );
(meta.definition#map)
(hex) 00 013 00 11 00 06
meta.definition#sequence: meta.map( #meta.definition, #meta.sequence );
(meta.definition#map)
(hex) 00 013 00 11 00 08
meta.definition#abstract: meta.map( #meta.definition, #meta.abstract );
(meta.definition#map)
(hex) 00 013 00 11 00 05

Using these serialized type definitions a client and server are able to confirm the format of metadata before attempting to communicate additional metadata information. Additional elements which fully describe the format of this meta data include:
meta.envelop: {@meta.expression[“size”]; @meta.expression[“type”]};
metaexpression#envelop: meta.map(#meta.expression, #meta.envelop);

The meta.envelop type is an extension to the Expression type. An envelop is designed to hold the data of another type in a binary buffer. The first argument specifies how the size of the buffer will be specified, while the second identifies the contents of the buffer. The envelop allows the data to be read without knowing how to interpret contained in the envelop.

dictionary.definition: { meta.envelop( @u16[“size”],
@meta.definition[“definition”] )
};
dictionary.entry: { @u16[“id”], @meta.name[“name”],
@dictionary.definition[“definition”] };
dictionary.map: { meta.array( @u16[“size”],
@dictionary.entry[“entry”] ) };

The dictionary types specify the format of a collection of specifications. The type identifier used in the map, the name of the type, and the full definition are included.

Using these definitions, the self referencing meta definitions specified above would be written to a buffer:

(hex)

00 15, 00 01 05 65 6D 70 74 79 00 04 00 12 00 00, 00 02 02 75 38 00 04 00 12 08 00, 00 03 03 75 31 36 00 04 00 12 10 00, 00 04 0A 6D 65 74 61 2E 62 61 73 69 63 00 16 00 14 02 00 0D 00 02 04 73 69 7A 65 00 0D 00 02 05 66 6C 61 67 73, 00 05 0D 6D 65 74 61 2E 61 62 73 74 72 61 63 74 00 10 00 14 01 00 0D 00 01 08 61 62 73 74 72 61 63 74, 00 06 08 6D 65 74 61 2E 6D 61 70 00 1D 00 14 02 00 0D 00 03 08 61 62 73 74 72 61 63 74 00 0D 00 03 08 63 6F 6E 63 72 65 74 65, 00 07 0F 6D 65 74 61 2E 65 78 70 72 65 73 73 69 6F 6E 00 02 00 15, 00 08 0D 6D 65 74 61 2E 73 65 71 75 65 6E 63 65 00 17 00 14 01 00 0F 00 0D 00 02 04 73 69 7A 65 00 0D 00 07 04 74 79 70 65, 00 09 0E 6D 65 74 61 2E 72 65 66 65 72 65 6E 63 65 00 15 00 14 02 00 0D 00 03 04 74 79 70 65 00 0D 00 0A 04 6E 61 6D 65, 00 0A 09 6D 65 74 61 2E 6E 61 6D 65 00 23 00 14 01 00 10 00 0F 00 0D 00 02 04 73 69 7A 65 00 0D 00 02 04 64 61 74 61 09 49 53 4F 36 34 36 2D 55 53, 00 0B 0D 6D 65 74 61 2E 65 6E 63 6F 64 69 6E 67 00 19 00 14 02 00 0D 00 07 04 64 61 74 61 00 0D 00 0A 08 65 6E 63 6F 64 69 6E67, 00 0C 0A 6D 65 74 61 2E 61 72 72 61 79 00 15 00 14 02 00 0D 00 07 04 73 69 7A 65 00 0D 00 07 04 74 79 70 65 00 0D 19 6D 65 74 61 2E 65 78 70 72 65 73 73 69 6F 6E 23 72 65 66 65 72 65 6E 63 65 00 06 00 13 00 07 00 09, 00 E 18 6D 65 74 61 2E 65 78 70 72 65 73 73 69 6F 6E 23 73 65 71 75 65 6E 63 65 00 06 00 13 00 07 00 08, 00 0F 15 6D 65 74 61 2E 65 78 70 72 65 73 73 69 6F 6E 23 61 72 72 61 79 00 06 00 13 00 07 00 0C, 00 10 18 6D 65 74 61 2E 65 78 70 72 65 73 73 69 6F 6E 23 65 6E 63 6F 64 69 6E 67 00 06 00 13 00 07 00 0B, 00 11 0F 6D 65 74 61 2E 64 65 66 69 6E 69 74 69 6F 6E 00 02 00 015, 00 12 15 6D 65 74 61 2E 64 65 66 69 6E 69 74 69 6F 6E 23 62 61 73 69 63 00 06 00 13 00 11 00 04, 00 13 13 6D 65 74 61 2E 8 65 66 69 0E 69 74 69 6F 6E 23 6D 61 70 00 06 00 13 00 11 00 06, 00 14 18 6D65 74 61 2E64 65 69 6E 69 74 69 6F6E 23 73 65 71 75 65 6E 63 65 00 06 00 13 00 11 00 08, 00 15 18 6D 65 74 61 2E 64 65 66 69 6E 69 74 69 6F 6E 23 61 62 73 74 72 61 63 74 00 06 00 13 00 11 00 05 (comas have been used to denote dictionary entry boundaries)

A typical client server communications system would first send this data and the server would confirm that it matches the server side serialized data representation. Until the metadata is compared and matched at a binary level, the server will not be able to confirm that the data can be read successfully. The present invention provides a reduced communications length between machines due to the agreement on data structure.

This format can be further extended to create a completely self referencing data format. A fully self referencing data format allows any data to be written to a file or other storage medium, and then at a later time any program can decipher the format using the data in the file. The specification for such a format is:

```
file; {
  meta.array( @u8[“size”], @dictionary.map[“meta dictionary”] ),
  meta.array( @u8[“size”], @dictionary.map[“data dictionary”] ),
  meta.identified( )
};
```

The format of the file is broken up into three sections. The first section defines the meta dictionary. The second section defines the data dictionary, and the third section is the actual data. The data dictionary defines all the data types used in the actual data. The meta dictionary defines all the data types used to define the data dictionary.

The meta dictionary is an array of dictionary maps. The first item in the array must be the core meta dictionary as defined above. This is the core information required to read additional data type specifications. The following dictionary maps can extend the core meta dictionary to define additional types required to define the data dictionary. The meta dictionary is self referencing and must include all definitions used in defining the meta dictionary itself.

The data dictionary defines all data types used in the actual data of the file Each data type may only be defined using the data types defined in the meta dictionary.

The meta identified type is used to specify the type of data contained in the file. The identifier read by meta.identified must be defined in the data dictionary part of the file. The actual data of the file follows the identifier and every type in the data must also be defined in the data dictionary part of the file.

The Data Session details further information on implementing a client/server session using the DRL.

When a data element has finished reading from a data stream, it must be instantiated to an in-memory representation of the same data. In the current implementation Java's Reflection is used to find a matching constructor for the specific data representation. Using the Person object as an example the following constructor would be expected.

```
Class Person
{
  Person( String firstName, String lastName, Date dateOfBirth )
  ...
}
```

The ascii_string would have been first returned as a String and the date_basic would have ben read as a Date object. The sequence instruction of the DRL will return an array of three objects; this does not necessarily require a matching constructor. A data content mapping system could be established which allowed mapping elements from one array into elements of a new array. The new array represents a different object. This mapping would then provide a mechanism to interpret and modify data without the need for an object on the host to match that object.

The Data Representation Language can be used to interface with legacy systems by an application programmer identifying the data representations of the legacy protocol elements. The programmer is then able to create the DRL type definitions and mappings to describe the legacy protocol elements. By doing this the DRL can speed the implementation of interfacing with the legacy system.

The current implementation provides the ability for an application to override the default methods of reading/writing and constructing objects. This ensures that specific needs of an applications data representation and internal object construction not covered by DRL can be provided by the application programmer.

The ability to keep Object marshalling separate from each object is an important aspect of the DRL. The separation ensures that communications elements are kept separate from the logic elements of a program.

The example grammar and implementation described above does not account for grouping of type identifies. The invention additionally provides the ability to group types so that naming conflicts do not occur. The elements such as “u16b” would be identified as “meta.u16b”. An import syntax would be introduced to the grammar to allow groups of elements to be used with a shorter name. For example the syntax: “import meta.*;” to import all names in the meta group. This would allow the “u16b” name to be used when referring to “meta.u16b”. Any time this data is being transferred between hosts, the full name should be used.

Data Session

The DRL defines how data can be transferred between two systems. However, to ensure that two systems agree on which types they understand a Data Session communications protocol is required. This protocol must include the message definitions which allow types to be identified with the same tag on two distributed systems.

As explained in the DRL description, once metadata can be exchanged between client and server a reference type map can be constructed. To negotiate on the values of the map we require additional messages to handle negotiation between two devices to handle data type agreement. The following provide an example of these messages.
meta_request: ascii_string [name] definition[definition];
meta_response: ascii_string[name] u16b[tag];

Each data type is identified using an ascii_string. This provides a unique identifier to check if the name and definition matches on the server side. After the metadata is found to match the client and sender can agree on the message tags to be used during communications. This agreement process starts when a meta_request is sent to the server, the server checks the specific definition to see if they match. If a match is found, a response can be made with the identifier to be assigned in the meta_response. With the eternal identifier assigned the client is then able to send the actual data.

The same meta_request and meta_response can be made by the server to the client in cases where the server requires to respond with a data type not yet agreed.

This type of boat strapping allows the most dynamic method of communications of any tape of data. Depending on the complexity of the communication protocol a simpler approach is to assume that both client and server are using a common type map which does not change. Using this methodology no meta data type identifier agreements need to be made. This has a downfall that the final solution is more rigid.

Additional messages to handle both type agreement and data messages used simultaneously on the same channel are not specified here. It is assumed that these message concepts, would either be extended to handle full data session agreement for other types of data, or that a separate data channel is opened for the specific use of data type identifier agreement.

Additional messages could also be defined for error conditions. In the embodiment above the value 0xFFFF could be assigned for the meta_reponse in situations where a mapping could not be matched between client and server.

Meta Versioning

Not discussed in the description of the method is the negotiation of meta information where multiple versions of the same type name is defined in the DRL. In a client server communications using the Data Session system, it is possible for a client and server to select a version of the type definition which matches on both client and server. This allows a communications between client and server to be as flexible as possible.

Two basic methods of versioning are possible. The first is to add a version identifier to the type definition. This allows the client and server to negotiate based on specific versions of a single type definition. The second method is for the server to keep multiple versions of type definitions associated with each name. When a request for a specific type is made, the server is able to match the correct version to the version in the request.

Drone Network Virtual Machine

The problem with prior art systems such as CORBA, SOAP and many others is that every individual request for information must be encoded, sent and reply received. The time taken in making a connection, sending and receiving is often much longer than the actual processing of the message. A better solution would be to allow a single message to contain multiple requests for information (method calls), in this way speeding processing and using communications more effectively. It is difficult to create a paradigm that allows for multiple requests to be sent in currently defined systems.

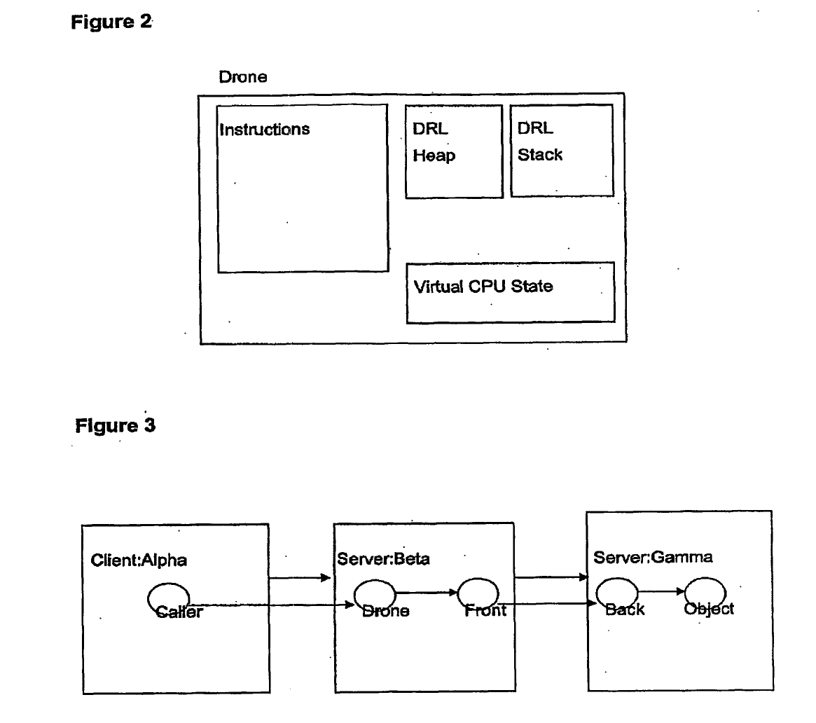

The concept of a virtual machine provides the ability to compile code to a byte code representation and then use a virtual CPU to execute the byte code on a native environment. The Colony Distributed Object Computing System extends this idea to a movable virtual computer (Drone). One embodiment is illustrated in FIG. 2. In most computer environments a program execution environment (computer or virtual machine) is made up of Program Instructions, Data(Heap), and Stack. A CPU or virtual machine executes the program instructions and uses the Stack as a temporary store for moving data between program functions.

The Colony Drone uses the Colony DRL to create a typed stack, typed heap, portable instructions and CPU State which includes Code Pointer and other elements in a serializable machine.

A typed stack allows the programmer to specify how each object placed on the stack should be serialized. This is required as a single instance of an object could be serialized in multiple ways. For example, given a date object there are many different ways that it can be serialized. Ensuring that the external type identifier is always recorded wit the object as it is placed on the Drone heap and Drone stack ensures the correct method of serialization occurs.

This type of Drone Network Virtual Machine is able to communicate between different computer systems as the DRL and Drone Network Virtual Machine can be placed on differing computer languages and architecture's and be implemented differently. The Drone Network VM simply specifies how the Drone Network VM is serialized. A very basic embodiment of such a Drone can be described via the DRL type system:
drone: code_pointer type_stack type_heap nvm_program_instruction;
code_pointer: unsigned_short_big
type_stack: array(unsigned_short_big, identified(any));
type_heap: array(unsigned_short_big, identified(any));
nvm_program_instruction: array(unsigned_short_big, unsigned_byte)

A Drone can be passed between a number of machines before returning to the source with a response.

Using the example location //abc.com.au/people/john.smith, an interface to a Person object may have the following:

```
Person
{
  String getFirstName( );
  String getLastName( );
  Date getDateOfBirth( );
}
```

If it is necessary to get the person's full name in a prior art system such as CORBA across a network, it would be required to make two distinct network request/response message pairs. First to return the first name, and the second to return the last name. Using the Drone of the present invention, it is possible to accomplish both in a single network request/response pair. For example by setting the instructions to be executed by the Network Virtual Machines:

Instructions
Load //abc.com.au/people/john.smith
Execute getLastName
Execute getFirstName
pop ascii_string
pop ascii_string

To encode these set of instructions and the virtual machine, a virtual machine state is created before the request has been sent:

```
CodePointer ( 0 )
Stack ( empty )
Heap (
  0. ascii_string, “//abc.com.au/people/john.smith”
  1. ascii_string, “getLastName”
  2. ascii_string, “getFirstName”
)
Code (
  1. load,  0  (heap  pointer  to
    “//abc.com.au/people/john.smith”)
  2. execute, 1 ( heap pointer )
  3. execute, 2 ( heap pointer )
  4. user_pop, ( getLastName )
  5. user_pop, ( getFirstName )
)
```

The client side caller will execute the first instruction(Load) and realize that the object is located on a remote computer. This Virtual Machine state will then be serialized so that it can be sent to the location of the object specified in the load instruction. The serialized state will be:

```
Code Pointer
00 00
Stack
00 00
Heap
00 03
                (ascii strings not in hex)
      00 02 20 “//abc.com.au/people/john.smith”
      00 02 0A “getLastName”
      00 02 0B “getFirstName”
Instructions
00 0F
      01 00 00 ( Load, 0 )
      02 00 01 ( Execute, 1 )
      02 00 02 ( Execute, 2 )
      03 00 02 ( user_pop, 2 )
      03 00 02 ( user_pop, 2 )
```

The full data representation is:
(hex) 00 00 00 00 03 00 02 20 0F 0F 41 42 43 0E 43 4F 4D 0E 41 55 0F 50 45 4F 50 4C 45 0E 4A 4F 48 4E 0E 53 4D 49 54 48 00 02 0A 47 45 54 2C 41 53 54 2E 41 4D 45 00 02 0B 47 45 54 2C 41 53 54 2E 41 4D 45 00 0F 01 00 00 02 00 01 02 00 02 03 00 02 03 00 02

The data is then sent to the receiver (//abc.com.au) which is able to rebuild its own internal representation of the Drone. The Load instruction is then re-executed and the object /people/john.smith is retrieved. The next two execute instructions will then be executed. The methods are resolved and executed in a way which best suites the environment in a java embodiment this can be accomplished through java's reflection interfaces. The result from each execute call is placed on the Drone's stack. The user_pop instruction is then attempted. This instruction must be executed by the client so the state of the virtual machine must be serialized and sent back to the client.

| | |
|---|---|
| | Code Pointer |
| (hex) | 00 03 |
| | Stack |
| | 00 02 |
| | (ascii strings not in hex) |
| | 00 02 04 “John” |
| | 00 02 05 “Smith” |
| | Heap |
| | 00 03 |
| | (ascii strings not in hex) |
| | 00 02 20 “//abc.com.au/people/john.smith” |
| | 00 02 0A “getLastName” |
| | 00 02 0B “getFirstName” |
| | Instructions |
| | 00 0A |
| | 01 00 00 ( Load, 0 ) |
| | 02 00 01 ( Execute, 1 ) |
| | 02 00 02 ( Execute, 2 ) |
| | 03 00 02 ( user_pop, 2 ) |
| | 03 00 02 ( user_pop, 2 ) |

In the example above, the instructions and heap are still sent. One optimization of this would remove executed instructions and heap data from the Drone. The client will receive the encoded virtual machine and recreate an internal representation. The code pointer is now at the instruction “user_pop” which signals that the program which initiated the call is returned and able to pop the values off the stack.

The above example uses the Drone to make two remote method calls. The same outcome of returning the users first and last name could have been achieved by serializing the Person object as described in the DRL and re-instantiating the object and calling the methods locally. A method such as “Person getPersion(String name)” could have been placed on the “//abc.com.au/people” object, and the Network virtual Machine used to call this method.

For simplicity the basic Drone example above does not include the ability to serialize additional security privileges. The invention can also include elements for security privileges to be encoded with the Drone either as additional instructions or additional elements of the Virtual Computer. These elements provide the Drone with privileges to access protected objects on the hosts it visits.

The Drone would minimally provide a basic set of instructions to cover:
Stack operations push, pop, peek, peekType.
Heap operations load, store
User operations user_push, user_peek
Drone operations moveTo, ReturnHost

These operations are by no means exhaustive and a Drone could include a full set of branching and test instructions as normally found in a computer. These instructions would be adapted to meet the Needs of the Typed Stack. Type Heap and Moveable nature of the Drone. Additional virtual computer elements to handle Exceptions, StackTrace's or other error handling elements of a modern programming languages can also be added to the Drone.

In the description so far, the Drone visits the host of the object to be called. This may not always be the case. An object may, alternatively, be called remotely from another type of front interface from another client. This is represented by FIG. 3. FIG. 3 displays a Client, Alpha which sends a Drone to Server Beta. The Drone executes a method on the Front interface of an object residing on Gamma and returning the result via Beta to Alpha.

Network Object Model

At a very basic level, problems associated with prior art distributed computing solutions revolve around the principle that a client requires a server to either perform an operation, receive information from the client, or send information requested by the client. The terms client and server refers to any host to host communication. This can describe a server acting as a client to another server, or various other combinations across multiple computers or between devices operating on the same computer. All these operations must occur by sending a sequence of binary data between the client and server.

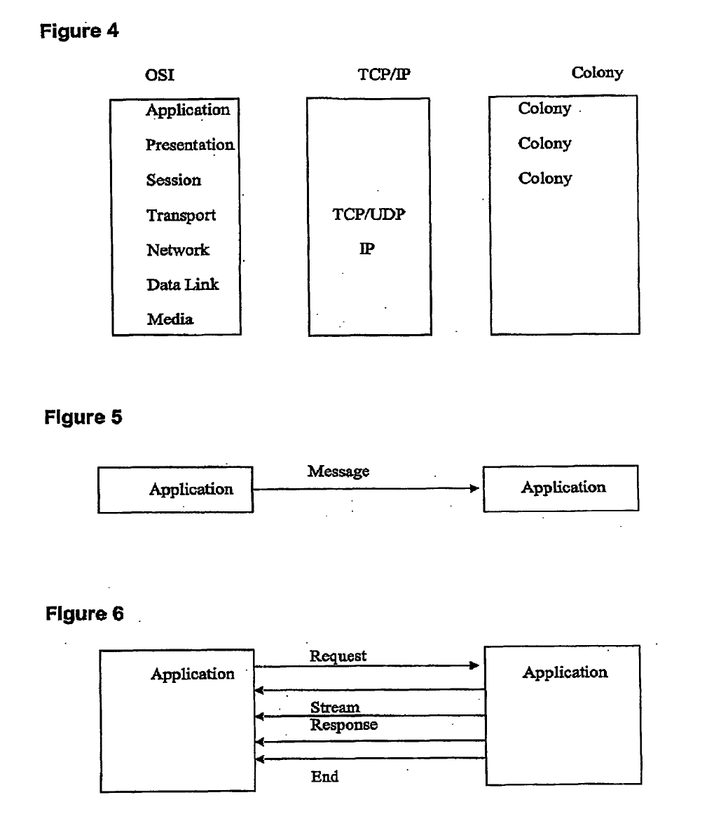

Referring to FIG. 4, the open Systems Interconnection (OSI) model defines the communication layers required for applications to communicate between hosts. The internet's TCP/IP protocol stack has become the defacto standard for communications at the network and transport layer. The communications systems of the present invention operate at the session, presentation and application layers.

The transport control protocol (TCP) provides the ability to connect and send data reliably between two applications on the same or different hosts. If a connection is lost the data will not be received. With an open connection the task of the session and presentation layers is to control how communication will be controlled, and how data will be encoded so that the receiving end will be able to decode the data.

At the session, presentation and application layers there is no well used standard or defacto standard. However there are a number of well defined paradigms that have been developed to deal with performance constraints of client/server communications. Currently these fall into three typical types of communication methods.

1. Message Based

Data is sent as a packet of data from the client to server. This is represented in FIG. 5. The data packet is directed to the application which may/may not send a response packet (ie asynchronous or synchronous). The data packet is normally small in size and provides a quick simple mechanism.

2. Stream Based

The HyperText Transfer Protocol (HTTP) is a common example of this type of client server communication. This is represented in FIG. 6. A small request is made for a document or data, and the information is returned as a data stream. This communication mechanism provides the best utilization of the underlying transport layer for large amounts of data.

3. Method (Remote Procedure Call) Based

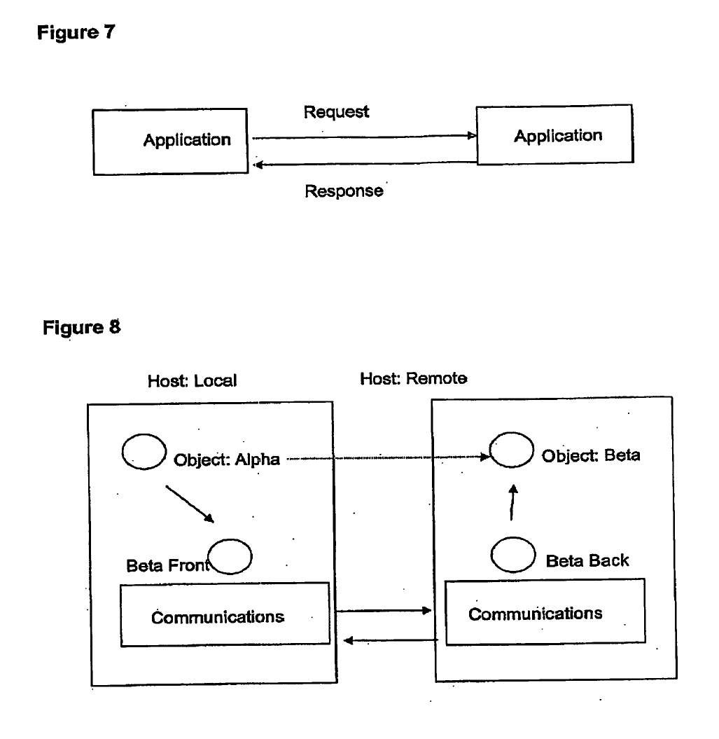

This is designed to allow a method/procedure to be called on a remote application. This is represented in FIG. 7. A request is sent to the server which acts as a proxy and calls the method. Any data required to be returned to the user is sent back in a response. CORBA uses this type of request/response mechanism

Each of these methods of communication have their own strengths and weaknesses when building a distributed system. The Colony Network Object Model provides a solution which allows a developer to use any of these systems for an application. This ensures the best performance for a specific remote method invocation.

To support the concept of method invocation on a remote object the network object model of the present invention uses the concept of a proxy object on the client which represents the functions available to the client. This is represented in FIG. 8. This concept is partly similar to CORBA's Stub and skeleton objects.

In Colony the stub object is called a ‘Front’ and has a matching ‘Back’ object on the server. This Front proxy allows the developer to design and implement the best method for communicating with the server object from a client. It differs from CORBA in that CORBA does not allow the user to implement the stub/skeleton.

The Front object provides the interface definition of the functionality to be provided on a remote client. An implemented Front object provides the specific encoding mechanisms required for the client to communicate with the host. The Back interface provides the matching server elements required to deliver the message from client to Back. An implemented Back object provides the matching decoding mechanisms for the implemented Front object.

In a java embodiment of the Colony Network Object Model the Front is defined as an interface with method signatures for the location and name of the object and an object type. An application would extend this interface to provide the additional elements required. Using the Person object example

```
public interface Front
{
  public LRL location( );
  public String type( );
}
public interface PersonFront
extends Front
{
  public String getFirstName( );
  public String getLastName( );
  public Date getDateOfBirth( );
}
```

An application programmer is then able to implement the PersonFront object to use the best method to communicate with the Back object. The Back object is designed to receive requests packaged by the implemented Front. The matching Back object is designed to invoke the Model object. The Model object providing the desired behaviour of the object.

The Front and Back mechanisms can be used to create a protocol stack where each Front implementation uses a Back interface to communicate with the client. For instance the PersonFront may use the following stacks on the client and server respectively.

Transport Layer

| Client | Server |
|---|---|
| | PersonModel Object |
| DronePersonFront | DronePersonBack |
| DroneClientBack | DroneServerBack |
| DataSessionBack | DataSessionServerBack |
| SocketClient | SocketServer |

The matching protocol stack on each side provides flexibility at each layer of the communications. The PersonFront can also be Implemented to use more than one protocol stack simultaneously between client and server, allowing a combination of remote method invocation, message queuing or streaming to be used. Alternatively, the Front can also be Implemented to call the Person Object locally where thee Front and Model reside in the same program. The following stack demonstrates an alternative implementation where the communications are based on SOAP using an underlying Message Queuing transport mechanism.

Transport Layer

| Client | Server |
|---|---|
| | PersonModel Object |
| SOAPPersonFront | SOAPPersonBack |
| SOAPClientBack | SOAPServerBack |
| MQSeriesClient | MQSeriesServer |

As shown in FIG. 8, a call from Alpha to a method on the object Beta is made to the Beta Front proxy object on the client. This uses the underlying communications mechanisms to communicate with the Beta Back object which in turn performs the required function on the Beta Model object

This type of Front object also provides the opportunity to provide a different interface which better matches a remote object interaction, than an object might use locally.

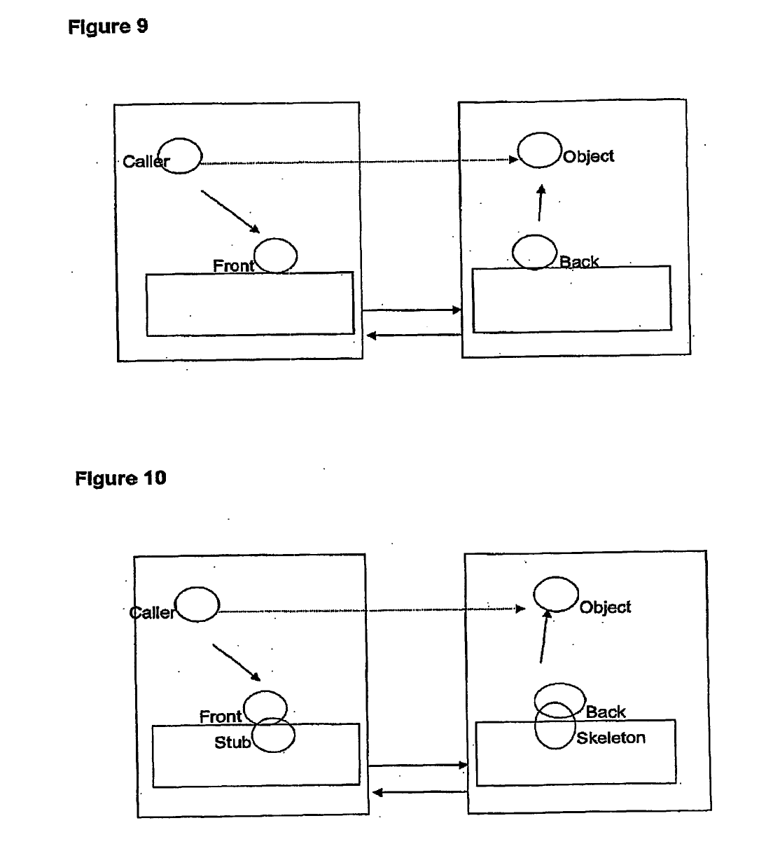

As illustrated in FIG. 9, the Front object resides on a client and communicates with a paired object Back. The Back object proxy's all requests from the client caller to the actual object contained on the server. This paradigm allows a front object to be implemented differently for different communication channels. It also allows for performance specific implementations for objects calling locally.

While the Front/Back paradigm provides for flexibility of implementations it can still require a large amount of programming if many objects need to be implemented. The concept of a Stub & Skeleton provides for default implementations for Front & Back objects and this is illustrated with reference to FIG. 10. This has been found to greatly reduce development time for most cases of distributed Front objects.

The default stub and skeleton can be overridden to implement channel based communications or other specific types of communication methods. The default stub uses the Drone Network Virtual Machine to encode a single method and parameters. The Drone is then managed by the DroneClientBack and its underlying protocol stack. In a java implementation the java.reflect.Proxy (jre 1.4) object is used to create a proxy. If the interface has been overridden in the Stub, that method is called, otherwise the default network virtual machine client is used. The method name and parameters are encoded in a Drone Network Virtual Machine and the request made.

On the server side, the Skeleton is used to find the object and then checks for a skeleton object method to override the default functionality. If no method is present the skeleton uses standard java reflection to find and execute the method.

Data Channels

A network virtual machine and other request/response paired communication systems such as CORBA and SOAP do not deal with streaming data very well. This is due to their request/response paired system of communication. In many scenarios of distributed computing this type of communication does not solve the problem well. An application programmer often requires a direct data stream between two locations to solve a problem efficiently.

Streaming communications is a well defined metaphor in software development. This metaphor is used in most communications systems which are external to a program's base environment. This includes both disk access using file streams and data communications using the well defined socket interface to TCP/IP. Operating systems such as IBM's OS/2 included the metaphor of a pipe which allowed two programs to communicate directly on the same machine.

Colony extends these concepts to provide direct object to object communication data channels that operate between either multiple objects operating on the same computer or multiple objects distributed across computers. One object or program is able to open a new data channel and then pass a Channel Identifier to a second object or program so that direct streaming communications can occur.

These data channels can also be used in conjunction with colony Data Representation Language and Drone Network Virtual Machine to provide a comprehensive object to object communications sub system as described in the Colony Network Object Model

Using the example of a remote object “//abc.com.au/people”, as noted above, a data channel could be used to return a large list of People objects. A function “Channel getAllPeople( )” on the server object returns all people as a stream of serialized People objects (as defined earlier). The client uses the network virtual machine to serialize a request to the getAllPeople method on the server object. The server back receives the end point of a Stream and registers the Server Channel; connecting it with the Stream returned. The Network Virtual Machine then serializes a return value of the Channel Identifier which provides the host and channel number. The client on receiving the Channel Identifier is able to open the Channel directly to the server. This Channel is then returned to the caller with end to end communications opened. A client would then use the DRL system to read and instantiate the Person objects returned. At anytime the client or server is able to end communications.

Channel Link Server

As earlier described the Channel Link Server is another aspect of invention and defines the session layer protocol which accepts and connects Data Channels from client to server. While the Data Channel aspect provides generic Object to Object data Channels, the Channel Link Server provides the ability to connect these Channels between two remote devices over a Transport Link, Layer.

The Data Channel system provides an identifier within a system which identifies a Channel endpoint. To connect this Channel endpoint to a client the end point on the server is connected to the Channel Link Server. The Channel Link Server now connected to the Data Channel returns an identifier which can be passed to the client (as described in the example Data Channel).

The client on receiving the Channel identifier passes it to a client which opens a channel to the Channel Link Server and sends it the identifier. The channel link server responds with a link success or failure. On success the client is able to return the connected Channel.

As the data channel is mediated by the Channel Link Server and Channel Link Client it is possible to implement this using any specified Transport Link Layer. As in the Network Object Model this provides the ability for flexibility for connecting data channels between devices.

The invention separates the Data Channels used within one device from the communications required to connect between different devices. This separation allows one device to connect Data Channels via different implementations at the same time using a consistent identifier throughout.

Naming

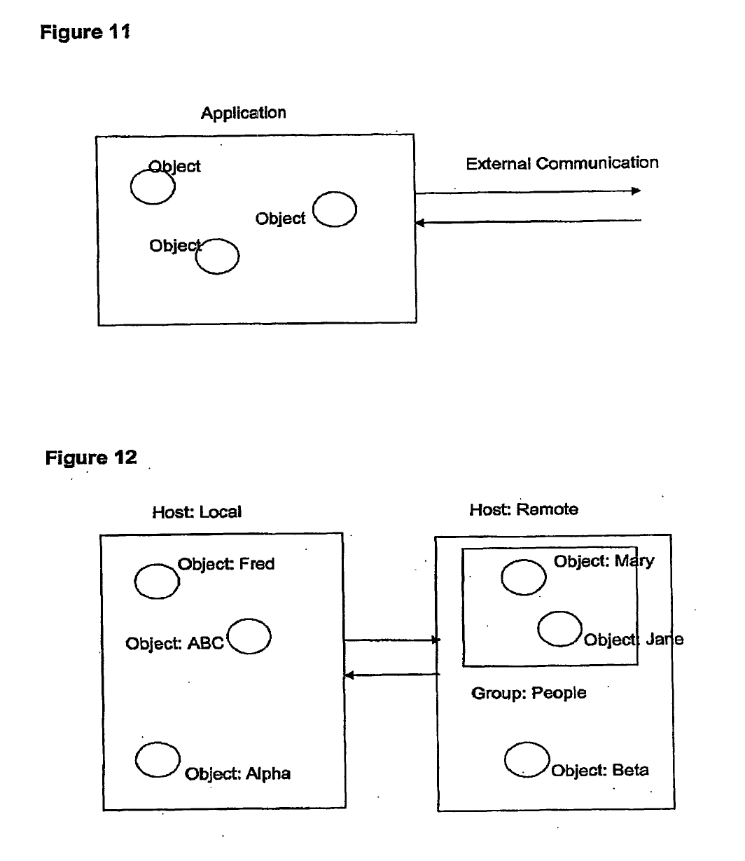

The methods of communication described above all provide a type of client/server communication. This creates a paradigm that allows a client to communicate with a server. However, in an object oriented programming (OOP) paradigm an application itself is made up of many objects. A method is still required to direct the communications to the correct location within an application. The communication needs to be able to be directed to the correct object. This is illustrated in FIG. 11.

The network object model of the present invention recognises that the same methods are needed to be able to communicate between objects in the same application, as required to communicate with objects external to an application. This allows transparency across both inter-host and external host communications.

To support these communication mechanisms both internally and externally a method of object resolution is required. Naming an object allows the various communications methods to be established between two objects. For example, we might name objects as illustrated in FIG. 12.

Naming objects in this way allows a message to be directed to either a local object or remote object. Additionally, grouping allows objects to be grouped within an application to allow better management of objects and access to those objects.

Colony uses Universal Resource Locators (URLs) to find objects. This ensures that object locations can be sent and/or received in documents, email, or in code.

The colony system maps these URL's to a host data collection system. This allows flexibility in design and implementation of a colony network. A URL such as
//abc.com.au/people/john.smith
could have the people object implemented with a database system. This allows access to the john.smith object to be mediated and managed by the host. The people object must then implement a set of basic containment interfaces. The Colony system uses the Zone/Realm aspect of the invention to provide this aspect of containment.
Zone & Realm

As introduced in the Naming aspect of the invention, a method of grouping objects is an important aspect of sorting and resolving the location of objects. The Zone & Realm elements of the invention work together with the naming and resolution system to provide this ability.

A Zone provides the basic containment interfaces for objects. Any object or data can be added to a Zone and provide a named identifier. Other elements of the system can use this and the naming system to resolve the location of an object both locally and remotely. Basic methods for the Zone include:
void put(PassKey key, String name, Object object);
Object get(PassKey key, String name);
Object remove(PassKey key, String name);
ObjectType getType(PassKey key, String name);

To provide security the Zone Interfaces are extended to include a pass key. A Realm provides the additional interfaces to manage the security access to each zone. This design is created to allow object access to be treated the same independent of accessing the object locally or remotely.

The Realm provides interfaces to handle connecting (log in) and disconnecting (log out) for users. It also includes the ability to manage user access. Basic methods for the Realm include:
PassKey connect(String userid, String password);
void disconnect(PassKey key);
void addUser(PassKey key, String userid, String password);
void removeUser(PassKey key, String userid);

The current Realm does not provide any security other than providing access to an object or not. It is assumed that access to an object is an all or nothing access. Once access is granted, all methods can be called on the object. Additional security can be implemented in the object and use the Realm security interfaces to check security privileges of the user. Access based on Roles is a further extension to the security elements which would provide access to certain objects based on the user or role.

In one embodiment a Zone is described as a Front Interface as described in the Network Object Model. This allows the Zone to be accessed remotely or locally. The method of how the Zone manages the contents of Its Zone may be managed differently for each Zone implementation. Each Zone is a member of a Realm and should defer all security decisions to its Realm.

A simple java implementation of a Zone may use a HashTable to hold a mapping between the name and the object, of each object in the Zone. The java containment interfaces can also be extended to use its own Java class loader to ensure that only certain objects are held in the specified Zone.

Each Zone participates in the Naming system. A name such as “//abc.com.au/people/fred” is defined as being on the host “abc.com.au” contained in the SystemRealm with an object “fred” contained in the Zone “people”. Additional Realms and/or Zones can be created in the SystemRealm as required by the application developer.

The base Zone of a host in the current system is referred to the SystemRealm. The SystemRealm provides the base security and containment for each host. The SystemRealm also provides additional services required for the Naming and Zone system. In a java implementation it provides the ability to map the java language type names to names provided by the application programmer. Renaming object class type names is important in distributed systems so that a common name can be used between systems implemented in different languages and architectures.

Message and Node System

The network virtual machine provides a distributed method calling system, and data channels provide streaming communications. A third method of communication is message based. A message based system uses small messages to send data between two objects. This type of asynchronous communications allows messages to be sent without requiring a reply. Often referred to as Message Queuing, it provides advantages over the previous types of communications.

Colony provides the concept of an object node to handle message based communications. This allows messages to be delivered directly to an object. This direct to an object delivery continues the Colony design philosophy of providing services required by an object directly, and providing an interface which is transparent between both local and remote objects.

The messaging system works together with the Zone and Naming system to resolve the location of an object and allow messages to be delivered to the correct object. The Data Representation Language is used to encode the contents of each message so that it can be transferred between hosts.

An important aspect of any computer system is handling resources correctly. To handle messages at an object level a system of sharing execution threads allows an object to not use any thread resources while idle, and be allocated threads dynamically when messages are directed to the object.

This ability for an object to handle messages independently and be assigned threads to carry out the tasks the messages require is a valuable aspect of the Colony Messaging system. It allows Objects to operate individually in a larger system. This creates a change in the way distributed programs are developed where the Colony system creates a network of objects each performing the required functions of a larger system. This network model of computing combined with the other elements of Colony system provides a very powerful and flexible system.

Each object in the colony network can be implemented to receive messages. The object is assigned a queue which is able to receive messages. A minimum and maximum number of threads can be allocated to the object to handle message processing. A timeout is also applied when no further messages are available, before the thread is returned to the resource pool. A timeout can also be applied for how long a message can wait before a new thread is taken from the resource pool and applied to the object to handle messages. This dynamic allocation ensures that objects receiving many messages obtain more processing power.

Each Node in the Colony network can have messages delivered synchronously or asynchronously. The synchronous method allows a message to be delivered and response returned. When the message is delivered the sending thread will wait for the response to be returned.

Synchronous message handling can be combined with the elements of the Network Virtual Machine to provide single message based method invocation which is handled directly by the Object.

In certain configurations the Object Model as described in the Network Object Model can be separate from the Node receiving the messages.

Transport Link Layer

The Transport Link Layer is a further aspect of invention and is specific to the needs of the transport layer being used. The Transport Link Layer connects the Colony communications services to such transport layers as simple TCP/IP socket, secure SSL link or other transport medium. The data session and channel link server are specific to the needs of the link layer being used. They provide the session management between the client and server. This is because a message based transport layer may have requirements differing from stream based transport layers.

This link layer is designed to provide a connection when requested to a specific end point. Unlike Transport mediums like TCP which provides interfaces to connect to any host, the Colony Link layer requires that the host location is setup earlier. This creates a minimal interface for session and presentation, layers to work with.

This link layer is important to the Network Object Model as it creates the base of the communications stack between two end points. It does not attempt to provide any additional services such as host resolution as this service has already been provided by the lower layers of the communications. The link layer can also be used to mask specific requirements of the transport layer (eg providing a stream based interface where the underlying interface is message based). The opposite can also be true; where the transport layer provides a stream based paradigm and the upper layers of a Network Object Model stack requires message based communications.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

1. In a communications network, having at least two devices adapted to communicate an instruction between the devices,
a front interface provided on one computer, and a substantially corresponding back interface provided on the other computer,
the improvement comprising:
selection means for selecting the encoding, for encoding the instruction, from a set of one or more available encodings.

2. A selection means as claimed in claim 1, wherein a stub is adapted to encode the instruction and a respective skeleton is adapted to decoding the instruction.

3. A selection means as claimed in claim 1, wherein the set of available encodings includes a stream based communication.

4. A selection means as claimed in claim 1, wherein the set of available encodings includes a virtual computer based communication.

5. A selection means as claimed in claim 1, wherein the set of available encodings includes a message based communication.

6. A selection means as claimed in claim 4, wherein the virtual computer is a computer comprising:
an object stack and/or an object heap, each of the stack and heap being adapted to store at least one object and its corresponding type identifier, and
an instruction set having at least one instruction adapted for execution by the virtual computer.

7. A communications and/or computer network including the selection means as claimed in claim 1.

8. A method of communicating an instruction from a first device to a second device, the first device having a first interface and the second device having a second interface, the method comprising the steps of:
selecting a communication protocol from a set of available communication protocols,
encoding the instruction in accordance with the selected protocol, and
transmitting the encoded instruction from the first device to a second device.

9. A method as claimed in claim 8, further comprising the steps of:
receiving the encoded instruction by the second device,
selecting a corresponding decoding protocol from an available set of communication protocols, and
decoding the instruction in accordance with the selected decoding protocol.

10. A method as claimed in claim 8, wherein at least one of the set of available protocols includes at least one of a message based protocol, a stream based protocol and/or a virtual computer.

11. A virtual computer, comprising:
an object stack and/or an object heap, each of the stack and heap being adapted to store at least one object and its corresponding type identifier, and
an instruction set having at least one instruction adapted for execution by the virtual computer.

12. A virtual computer as claimed in claim 11, further comprising:
a state register being adapted to provide at least one operating register.

13. A virtual computer as claimed in claim 11, wherein the stack enables a user to specify how each object placed on the stack is to be serialised.

14. A virtual computer as claimed in claim 11, wherein an external identifier is recorded with an object as the object is placed on the heap.

15. A method of executing an instruction set using a virtual computer, in a communications network having at least two devices, the method comprising the steps of:
serialising the virtual computer to a data buffer in a first device, and
transmitting the data buffer to from the first device to a second device.

16. A method as claimed in claim 15, further comprising:
receiving the serialised data buffer,
un-serialising the data buffer, and
executing at least one instruction of the virtual computer.

17. A method as claimed in claim 15, wherein the method is repeated to transmit the virtual computer to a further device.

18. A method as claimed in claim 15, wherein the virtual computer is a computer comprising:
an object stack and/or an object heap, each of the stack and heap being adapted to store at least one object and its corresponding type identifier, and
an instruction set having at least one instruction adapted for execution by the virtual computer.

19. A communications format for use in providing communication between at least two devices, the format comprising:
a first portion representing data, the first portion being adapted to be rendered and communicated in an electronically communicable format, such as binary format, and
a second portion representing metadata for defining a meaning to be given to the first portion, the meaning given to the second portion being definable for each communication.

20. A format as claimed in claim 19, wherein the second portion is adapted to be rendered and communicated in an electronically communicable format, such as binary format.

21. A format as claimed in claim 19, wherein the definition given to the second portion is selectable from a set of at least one definitions.

22. A format as claimed in claim 19, wherein the first and second portions are communicated in separate transmissions.

23. A format as claimed in claimed in claim 19, wherein the second portion represents a selection of at least one meaning to be given to the first portion.

24. A format as claimed in claim 23, wherein the meaning to be given to the first portion is stored in at least one of the two devices.

25. A communications format as claimed in claim 19, wherein the second portion further provides information on reading the data.

26. A format as claimed in claim 19, wherein the second portion is a tag(s).

27. A format as claimed in claim 26, wherein the tag(s) is an element of a map providing correlation to stored information defining the second portion.

28. A format as claimed in claim 27, wherein the map is adapted to map an external identifier to an internal identifier.

29. A format as claimed in claim 19, wherein the metadata is serializable for communication between the devices.

30. A format as claimed in claim 19, wherein the metadata comprises metadata.

31. A format as claimed in claim 19, wherein the format only describes the data.

32. A method of communicating between at least two devices, the method comprising the steps of:
providing a first portion representing data, the first portion being adapted to be rendered and communicated in an electronically communicable format, such as binary format, and
providing a second portion representing metadata for defining a meaning to be given to the first portion, the meaning given to the second portion being definable for each communication.

33. A method as claimed in claim 32, wherein the second portion is adapted to be rendered and communicated in an electronically communicable format, such as binary format.

34. A method as claimed in claim 32, wherein the definition given to the second portion is selectable from a set of at least one definitions.

35. A method as claimed in claim 32, wherein the first and second portions are communicated in separate transmissions.

36. A method as claimed in claim 32, wherein the second portion represents a selection of at least one meaning to be given to the first portion.

37. A method as claimed in claim 36, wherein the meaning to be given to the first portion is stored in at least one of the two devices.

38. A method as claimed in claim 32, wherein the second portion further provides information on reading the data.

39. A method as claimed in claim 32, wherein the second portion is a tag(s).

40. A method as claimed in claim 39, wherein the tag(s) is a map providing correlation to stored information defining the second portion.

41. A method as claimed in claim 40, wherein the map is adapted to map an external identifier to an internal identifier.

42. A method as claimed in claim 32, wherein the metadata is serializable for communication between the devices.

43. A method as claimed in claim 32, wherein the metadata comprises metadata.

44. A method as claimed in claim 32, wherein the format only describes the data.

45. An architecture for a communication device, the architecture comprising:
a programming layer for communications internal to the device,
a communications layer for communications external to the device, wherein
the external communications are in accordance with the format comprising:
a first portion representing data, the first portion being adapted to be rendered and communicated in an electronically communicable format, such as binary format, and
a second portion representing metadata for defining a meaning to be given to the first portion, the meaning given to the second portion being definable for each communication.

46. An architecture for a communication device, the architecture comprising:
a programming layer for communications internal to the device,
a communications layer for communications external to the device, wherein
the external communications are in accordance with selection means for selecting encoding, for encoding the instruction, from a set of one or more available encodings.

47. An architecture for a communication device, the architecture comprising:
a programming layer for communications internal to the device,
a communications layer for communications external to the device, wherein
the external communications include a virtual computer comprising:
an object stack and/or an object heap, each of the stack and heap being adapted to store at least one object and its corresponding type identifier, and
an instruction set having at least one instruction adapted for execution by the virtual computer.

48. Apparatus adapted to provide communications from a first device to a second device, said apparatus including:
processor means adapted to operate in accordance with a predetermined instruction set,
said apparatus, in conjunction with said instruction set, being adapted to perform a method comprising the steps of:
selecting a communication protocol from a set of available communication protocols,
encoding an instruction in accordance with the selected protocol, and
transmitting the encoded instruction from the first device to a second device.

49. Apparatus adapted to execute an instruction set using a virtual computer, said apparatus including:
processor means adapted to operate in accordance with a predetermined instruction set,
said apparatus, in conjunction with said instruction set, being adapted to perform a method of executing the instruction set comprising the steps of:
serialising the virtual computer to a data buffer in a first device, and
transmitting the data buffer to from the first device to a second device.

50. Apparatus adapted to communicate via a format comprising:
a first portion representing data, the first portion being adapted to be rendered and communicated in an electronically communicable format, such as binary format, and a second portion representing metadata for defining a meaning to be given to the first portion, the meaning given to the second portion being definable for each communication, said apparatus including:
processor means adapted to operate in accordance with a predetermined instruction set,
said apparatus, in conjunction with said instruction set, being adapted to perform the communication.

51. A computer program product including:
a computer usable medium having computer readable program code and computer readable system code embodied on said medium for providing communications from a first device to a second device within a computer system, said computer program product including:
computer readable code within said computer usable medium for performing a method comprising the steps of:
selecting a communication protocol from a set of available communication protocols,
encoding an instruction in accordance with the selected protocol, and
transmitting the encoded instruction from the first device to a second device.

52. A computer program product including:
a computer usable medium having computer readable program code and computer readable system code embodied on said medium for executing an instruction set using a virtual computer within a computer system, said computer program product including:
computer readable code within said computer usable medium for performing a method comprising the steps of:
serialising the virtual computer to a data buffer in a first device, and
transmitting the data buffer to from the first device to a second device.

53. A computer program product including:
a computer usable medium having computer readable program code and computer readable system code embodied on said medium for providing communications within a computer system, said computer program product including:
computer readable code within said computer usable medium being adapted to communicate via a format comprising:
a first portion representing data, the first portion being adapted to be rendered and communicated in an electronically communicable format, such as binary format, and
a second portion representing metadata for defining a meaning to be given to the first portion, the meaning given to the second portion being definable for each communication.

54. A device, selection means, network substantially as herein disclosed with reference to the accompanying drawings.

55. A method substantially as herein disclosed with reference to the accompanying drawings.

56. Apparatus adapted to provide communications from a first device to a second device, said apparatus including:
processor means adapted to operate in accordance with a predetermined instruction set, said apparatus, in conjunction with said instruction set, being adapted to perform a method comprising the steps of:
providing a first portion representing data, the first portion being adapted to be rendered and communicated in an electronically communicable format, such as binary format, and
providing a second portion representing metadata for defining a meaning to be given to the first portion, the meaning given to the second portion being definable for each communication.

57. A computer program product including:
a computer usable medium having computer readable program code and computer readable system code embodied on said medium for providing communications from a first device to a second device within a computer system, said computer program product including:
computer readable code within said computer usable medium for performing a method comprising the steps of:
providing a first portion representing data, the first portion being adapted to be rendered and communicated in an electronically communicable format, such as binary format, and
providing a second portion representing metadata for defining a meaning to be given to the first portion, the meaning given to the second portion being definable for each communication.
